(19) United States
(12) Patent Application Publication
(10) Pub. No.: US 2004/0258843 A1
(43) Pub. Date: Dec. 23, 2004

(54) Dual sided nonwoven articles for cleaning

(75) Inventors: Imad Qashou, Cornelius, NC (US); Joseph F. Merker IV, Pittsgrove, NJ (US); Nick Carter, Mooresville, NC (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/818,274

(22) Filed: Apr. 5, 2004

Related U.S. Application Data
(60) Provisional application No. 60/460,914, filed on Apr. 7, 2003.

(51) Int. Cl. B05D 1/30

(52) U.S. Cl. 427/420; 427/421.1

(57) ABSTRACT

The present invention relates to a dual performance cleaning article, wherein said article is comprised of a first abrasive meltblown surface that facilitates the process of loosening particulates, such as dust and dirt, and an opposing second soft, air permeable surface, which is capable of absorbing and/or picking up particulates and liquids. The meltblown layer comprises coarse discontinuous filamentary elements, formed from adjusting the variable commonly utilized in the traditional meltblown method.

### TECHNICAL FIELD

The present invention relates generally to a cleaning article, and specifically to a dual performance cleaning article comprising two functionally diverse surfaces, wherein said article has an abrasive side that facilitates the process of loosening particulates, such as dust and dirt, and an opposing air permeable, soft, absorbent side, such material being imminently suitable for application in cleaning and cleansing applications.

### BACKGROUND OF THE INVENTION

The general use of nonwoven fabrics as cleaning and cleansing articles is well known in the art. Various end-use articles are commercially available which utilize a combination of topical, performance enhancing additives and/or multi-layered laminate constructions. Enhanced versions of articles used in cleaning hard-surfaces further incorporate an optional cleaning fluid, including but not limited to, disinfectants, polishing solutions, and glass cleaners.

One such layer commonly utilized in a multi-layer cleaning construct is a meltblown layer. Meltblown layers are often incorporated into cleaning articles in order to provide the article with absorbent and/or abrasive features. A meltblown layer is comprised of micrometer scale filaments, which are drawn and fragmented by a high velocity air stream, and deposited into a self-annealing mass. The meltblowing process is well known in the art and described in U.S. Pat. No. 4,041,203, to Brock, et al., which is hereby incorporated by reference. Combining a meltblown layer along with various other nonwoven layers, allows for an end-use article that can perform multiple tasks.

It has become desirable, by way of convenience, to be able to utilize a single cleaning article for multiple tasks, wherein a single use wipe can abrade and/or disrupt a build up of dust or dirt, as well as, absorb or collect any resultant particulates and liquids. Past attempts have been made to construct a nonwoven, abrasive and absorbent hard surface cleaning laminate, such as described in U.S. Pat. No. 5,560,794 to Currie, et al., hereby incorporated by reference, wherein the layered abrasive and absorbent construct is comprised of three-dimensional conical protrusions, which taper into an aperture. The aforementioned apertures, however, only exist within the abrasive portion of the construct, limiting the amount of air that may flow through the entire construct. There remains a need for a dual performance cleaning or cleansing laminate that allows for efficient airflow through the entire laminate, so as to provide a product capable of creating a sufficient amount of lather upon the introduction of a cleaning agent.

The present invention contemplates a dual performance, laminate wipe, wherein one surface is comprised of an abrasive meltblown layer and the opposing surface is comprised of a soft, absorbent, air permeable, nonwoven layer. Further, the wipe of the invention is comprised of bonded regions and distinct pillow regions defined by the bonded regions. Further still, the invention efficiently integrates two separate cleaning articles into a single disposable cleaning article, thus promoting efficient manufacture, while obtaining the desired dual task management.

### SUMMARY OF THE INVENTION

The present invention relates to a dual performance cleaning article, wherein said article is comprised of a first abrasive meltblown surface that facilitates the process of loosening particulates, such as dust and dirt, and an opposing second soft, air permeable surface, which is capable of absorbing and/or picking up particulates and liquids. The meltblown layer comprises coarse discontinuous filamentary elements, formed from adjusting the variable commonly utilized in the traditional meltblown method. Such filamentary elements may be formed from a polymer selected from the group consisting of polyolefins, polyesters, polyetheresters, and polyamide. Suitable absorbent, air permeable webs include, but are not limited to filamentary webs and fibrous carded webs comprised of natural fiber, synthetic fibers, and the blends thereof.

In accordance with the present invention, the nonwoven cleaning article is comprised of “pillows” or unbonded regions wherein the two layers remain essentially separate from one another. Upon the introduction of a cleaning agent, the pillow regions allow for a maximum amount of air to flow through the laminate, but also, the ability for the separate layers within the pillow regions to come in contact with and pass over one another in an uninhibited manner assists in the formation of a lather. The article is bonded utilizing conventional means, such as adhesive bonding, ultrasonic bonding, and thermal calendaring, so as to form at least two or more enclosed, unique, and distinct pillow regions. It is contemplated that nonwovens embodying the principles of the present invention are especially suitable as a wet wipe substrate for cleaning both domestic and industrial surfaces, and further for use in skin/facial cleaning. The present nonwoven fabric wipe can be provided in forms that are suitable for use as a dry wipe to absorb liquid, and to provide extra scrubbing effect, as needed.

Further, it is within the purview of the present invention to optionally utilize specific additives or a combination of additives, so as to enhance the performance, visual appearance, or aromatic properties, wherein such additives are meant to include, but not limited to anti-microbial or disinfecting agents, pigments, and/or fragrances. Such enhancing agents may be provided in the form of a melt-additive in the polymer from which the coarse meltblown layer is formed, or may comprise a post surface treatment applied to the laminate itself or deposited into a container or film packaging from which the end-use article may be dispensed.

Other features and advantages of the present invention will become readily apparent from the following detailed description, the accompanying drawings, and the appended claims.

### BRIEF DESCRIPTION OF THE DRAWINGS

FIG. 1 is a photomicrograph of the abrasive side of the nonwoven cleaning article in practicing the present invention;

FIG. 2 is a photomicrograph of the air permeable, absorbent side of the nonwoven cleaning article in practicing the present invention;

FIG. 3 is a photomicrograph on a macroscopic scale of the abrasive side of the nonwoven cleaning article in practicing the present invention; and

FIG. 4 is a photomicrograph on a macroscopic scale of the air permeable, absorbent side of the nonwoven cleaning article in practicing the present invention.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

The nonwoven dual sided cleaning article of the present invention is comprised of coarse denier meltblown filaments, wherein a spunbond resin is utilized with a conventional meltblown process so as to capture thicker filaments. In general, the meltblown process utilizes a molten polymer is extruded under pressure through orifices in a spinneret or die. Traditionally, high velocity air impinges upon and entrains the filaments as they exit the die. Usually the energy of this step is such that the formed filaments are greatly reduced in diameter and are fractured so that microfibers of finite length are produced. Utilizing a spunbond resin with a lower melt flow rate, as well as lowering the air pressure, however, allows the collected filaments to take on a thicker diameter, providing the overall collective web with a desirable coarse texture. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203. The resultant filaments may be of various cross-sectional profiles, which are not considered a limitation to the practice of the present invention.

In a particular embodiment, a polypropylene spunbond resin, commercially known as PP3155 made available by Exxon Chemical Company was utilized. The aforementioned resin had a 35 MFR and was extruded at an average die temperature of 562° Fahrenheit with an approximate throughput of 7.1 grams/hole/min. Further, the distance between the meltblown die and the collective surface was around the order of 19 inches. The resultant meltblown filaments have a denier between that of 5 and 50 microns. Suitable polymers that may be used in the meltblowing process of the present invention include those selected from the group consisting of polyolefins, polyesters, polyetheresters, and polyamide.

Optionally, prior to extrusion, the single polymeric resin can be compounded with various melt-additives, so as to assist with the processing conditions, enhance the performance of the web, or enhance the appearance of the web, such additives including, but not limited to thermal stabilizers, colorants, and aromatics.

The dual purpose cleaning article of the present invention also comprises a soft, air permeable, absorbent layer capable of picking up liquids and particulates. A nonwoven of this nature may be a fibrous nonwoven layer or a continuous filament nonwoven layer. In general, continuous filament nonwoven fabric formation involves the practice of the spunbond process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. The web is then at least temporarily consolidated, usually by means involving heat and pressure, such as by thermal point bonding. Using this means, the web or layers of webs are passed between two hot metal rolls, one of which has an embossed pattern to impart and achieve the desired degree of point bonding, usually on the order of 10 to 40 percent of the overall surface area being so bonded.

When staple fibers are utilized to form the air permeable nonwoven layer, the fibers may begin in a bundled form as a bale of compressed fibers. In order to decompress the fibers, and render the fibers suitable for integration into a nonwoven fabric, the bale is bulk-fed into a number of fiber openers, such as a garnet, then into a card. The card further frees the fibers by the use of co-rotational and counter-rotational wire combs, then depositing the fibers into a lofty batt. The lofty batt of staple fibers can then optionally be subjected to fiber reorientation, such as by air-randomization and/or cross-lapping, depending upon the ultimate tensile properties of the resulting nonwoven fabric. The fibrous batt is integrated into a nonwoven fabric by application of suitable bonding means, including, but not limited to, use of adhesive binders, thermobonding by calender or through-air oven, and hydroentanglement.

Optionally, the air permeable nonwoven layer may be that of a three-dimensionally entangled nonwoven fabric, wherein in the fabric is hydroentangled on a three-dimensional image transfer device. Such three-dimensional image transfer devices are disclosed in U.S. Pat. No. 5,098,764, which is hereby incorporated by reference; with the use of such image transfer devices being desirable for providing a fabric with enhanced physical properties as well as an aesthetically pleasing appearance.

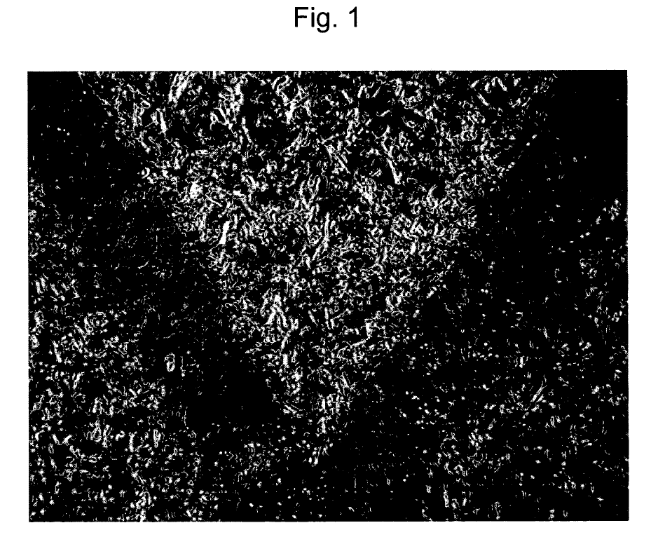

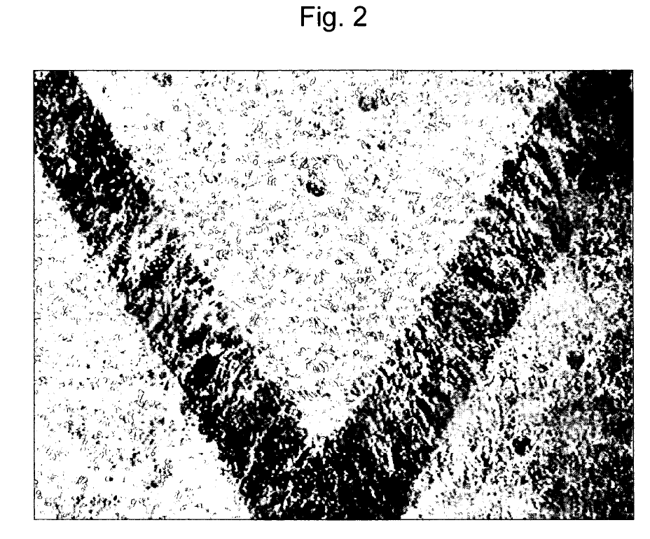

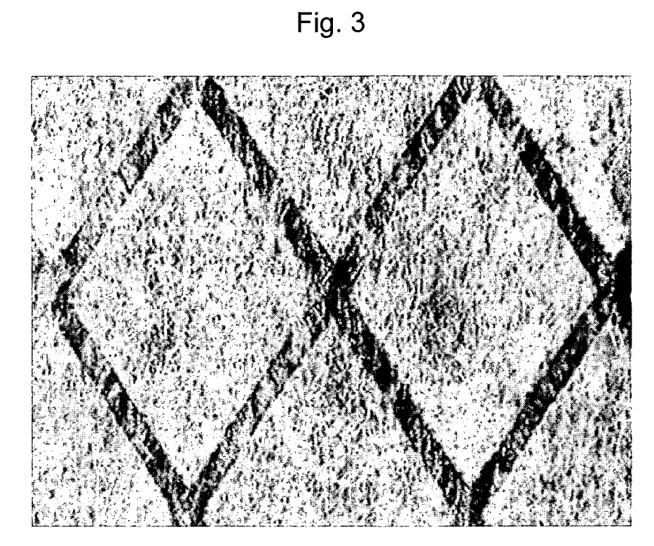

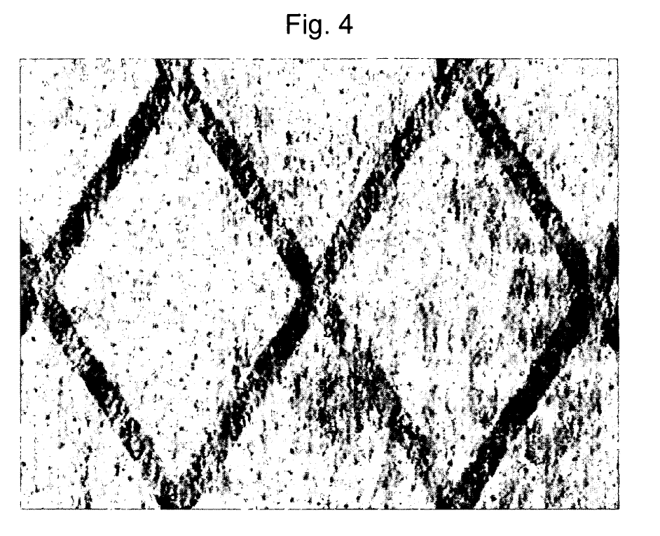

The two different nonwoven layers may be juxtaposed and continuously bonded so as form a plurality of “pillows”, wherein the two layers within the pillow regions remain essentially unattached. The separate layers of the pillow regions are uninhibited by way of movement during the cleaning process contributing to formation of lather. Subsequent to positioning the abrasive layer and the air permeable absorbent layer, the two layers may be bonded, preferably thermally calendered, wherein the laminate is passed between two metal rolls, one of which is comprised of a pattern. The pattern is imparted into the laminate forming bonded regions. Bonded regions within the laminate in turn define the slightly raised outer most edges of the unbonded “pillow” regions. FIGS. 1 through 4 are indicative of the fabric of the present invention.

In accordance with the present invention, the dual sided nonwoven article includes the use of various aqueous and non-aqueous compositions. The dual performance article embodying the principles of the present invention is especially suitable for home care cleaning or cleansing articles. The dual sided nonwoven article may be used in various home care applications, wherein the end use article may be a dry or wet hand held sheet, such as a wipe, a mitt formation, or a cleaning implement capable of retaining the dual sided article. The various end uses suitable for cleaning household surfaces such as, kitchen and bathroom countertops, sinks, bathtubs, showers, appliances, and fixtures.

Cleansing compositions suitable for such end use applications include those that are described in U.S. Pat. No. 6,103,683 to Romano, et al., U.S. Pat No. 6,340,663 to Deleo, et al., U.S. Pat. No. 5,108,642 to Aszman, et al., and U.S. Pat. No. 6,534,472 Arvanitidou, et al., all of which are hereby incorporated by reference. Selected cleaning compositions may also include surfactants, such as alkylpolysaccharides, alkyl ethoxylates, alkyl sulfonates, and mixtures thereof; organic solvent, mono- or polycarboxylic acids, odor control agents, such as cyclodextrin, peroxides, such as benzoyl peroxide, hydrogen peroxide, and mixtures thereof, thickening polymers, aqueous solvent systems, suds suppressors, perfumes or fragrances, and detergent adjuvants, such as detergency builder, buffer, preservative, antibacterial agent, colorant, bleaching agents, chelants, enzymes, hydrotropes, and mixtures thereof. The aforementioned compositions preferably comprise from about 50% to about 500%, preferably from about 200% to about 400% by weight of the dual sided nonwoven cleaning article.

The dual performance article embodying the principles of the present invention is also suitable for personal cleaning or cleansing articles. Non-limiting examples of such applications include dry or wet facial wipes, body wipes, and baby wipes. Suitable methods for the application of various aqueous and non-aqueous compositions comprise aqueous/alcoholic impregnates, including flood coating, spray coating or metered dosing. Further, more specialized techniques, such as Meyer Rod, floating knife or doctor blade, which are typically used to impregnate cleansing solutions into absorbent sheets, may also be used. The following compositions preferably comprise from about 50% to about 500%, preferably from about 200% to about 400% by weight of the dual sided nonwoven article.

The nonwoven laminate incorporates a functional additive, such as an alpha-hydroxycarboxylic acid, which refers not only the acid form but also salts thereof. Typical cationic counterions to form the salt are the alkali metals, alkaline earth metals, ammonium, C₂-C₈ trialkanolammonium cation and mixtures thereof. The term “alpha-hydroxycarboxylic acids” include not only hydroxyacids but also alpha-ketoacids and related compounds of polymeric forms of hydroxyacid.

Amounts of the alpha-hydroxycarboxylic acids may range from about 0.01 to about 20%, preferably from about 0.1 to about 15%, more preferably from about 1 to about 10%, optimally from about 3 to about 8% by weight of the composition which impregnates the substrate. The amount of impregnating composition relative to the substrate may range from about 20:1 to 1:20, preferably from 10:1 to about 1:10 and optimally from about 2:1 to about 1:2 by weight.

Further, a humectant may be incorporated with the aforementioned alpha-hydroxycarboxylic compositions. Humectants are normally polyols. Representative polyols include glycerin, diglycerin, polyalkylene glycols and more preferably alkylene polyols and their derivatives. Amounts of the polyol may range from about 0.5 to about 95%, preferably from about 1 to about 50%, more preferably from about 1.5 to 20%, optimally from about 3 to about 10% by weight of the impregnating composition.

A variety of cosmetically acceptable carrier vehicles may be employed although the carrier vehicle normally will be water. Amounts of the carrier vehicle may range from about 0.5 to about 99%, preferably from about 1 to about 80%, more preferably from about 50 to about 70%, optimally from about 65 to 75% by weight of the impregnating composition.

Preservatives can desirably be incorporated protect against the growth of potentially harmful microorganisms. Suitable traditional preservatives for compositions of this invention are alkyl esters of para-hydroxybenzoic acid. Other preservatives which have more recently come into use include hydantoin derivatives, propionate salts, and a variety of quatenary ammonium compounds. Preservatives are preferably employed in amounts ranging from 0.01% to 2% by weight of the composition.

The cosmetic composition may further include herbal extracts. Illustrative extracts include Roman Chamomile, Green Tea, Scullcap, Nettle Root, Swertia laponica, Fennel and Aloe Vera extracts. Amount of each of the extracts may range from about 0.001 to about 1%, preferably from about 0.01 to about 0.5%, optimally from about 0.05 to about 0.2% by weight of a composition.

Additional functional cosmetic additives may also include vitamins such as Vitamin E Acetate, Vitamin C, Vitamin A Palmitate, Panthenol and any of the Vitamin B complexes. Anti-irritant agents may also be present including those of steviosides, alpha-bisabolol and glycyhrizzinate salts, each vitamin or anti-irritant agent being present in amounts ranging from about 0.001 to about 1.0%, preferably from about 0.01 to about 0.3% by weight of the composition.

These impregnating compositions of the present invention may involve a range of pH although it is preferred to have a relatively low pH, for instance, a pH from about 2 to about 6.5, preferably from about 2.5 to about 4.5.

In addition to cosmetic compositions, lotions may be incorporated into the dual sided nonwoven article. The lotion preferably also comprises one or more of the following: an effective amount of a preservative, an effective amount of a humectant, an effective amount of an emollient; an effective amount of a fragrance, and an effective amount of a fragrance solubilizer.

As used herein, an emollient is a material that softens, soothes, supples, coats, lubricates, or moisturizes the skin. The term emollient includes, but is not limited to, conventional lipid materials (e.g. fats, waxes), polar lipids (lipids that have been hydrophylically modified to render them more water soluble), silicones, hydrocarbons, and other solvent materials. Emollients useful in the present invention can be petroleum based, fatty acid ester type, alkyl ethoxylate type, fatty acid ester ethoxylates, fatty alcohol type, polysiloxane type, mucopolysaccharides, or mixtures thereof.

Humectants are hygroscopic materials that function to draw water into the stratum comeum to hydrate the skin. The water may come from the dermis or from the atmosphere. Examples of humectants include glycerin, propylene glycol, and phospholipids.

Fragrance components, such as perfumes, include, but are not limited to water insoluble oils, including essential oils. Fragrance solubilizers are components which reduce the tendency of the water insoluble fragrance component to precipitate from the lotion. Examples of fragrance solubilizers include alcohols such as ethanol, isopropanol, benzyl alcohol, and phenoxyethanol; any high HLB (HLB greater than 13) emulsifier, including but not limited to polysorbate; and highly ethoxylated acids and alcohols.

Preservatives prevent the growth of micro-organisms in the liquid lotion and/or the substrate. Generally, such preservatives are hydrophobic or hydrophilic organic molecules. Suitable preservatives include, but are not limited to parabens, such as methyl parabens, propyl parabens, and combinations thereof.

The lotion can also comprise an effective amount of a kerotolytic for providing the function of encouraging healing of the skin. An especially preferred kerotolytic is Allantoin ((2,5-Dioxo-4-Imidazolidinyl)Urea), a heterocyclic organic compound having an empirical formula C₄, H₆. N₄, O₃. Allantoin is commercially available from Tri-K Industries of Emerson, N.J. It is generally known that hyperhydrated skin is more susceptible to skin disorders, including heat rash, abrasion, pressure marks and skin barrier loss. A premoistened wipe according to the present invention can include an effective amount of allantoin for encouraging the healing of skin, such as skin which is over hydrated.

U.S. Pat. No. 5,534,265, issued Jul. 9, 1996; U.S. Pat. No. 5,043,155, issued Aug. 27, 1991; and U.S. Pat. No. 5,648,083, issued Jul. 15, 1997, are incorporated herein by reference for the purpose of disclosing additional lotion ingredients.

The lotion can further comprise between about 0.1 and about 3 percent by eight Allantoin, and about 0.1 to about 10 percent by weight of an aloe extract, such as aloe vera, which can serve as an emollient. Aloe vera extract is available in the form of a concentrated powder from the Rita Corporation of Woodstock, Ill.

Further, latherants may be incorporated within the dual sided cleaning article. Non-limiting examples of anionic lathering surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975, all of which are incorporated by reference herein in their entirety. A wide variety of anionic lathering surfactants are useful herein. Non-limiting examples of anionic lathering surfactants include those selected from the group consisting of sarcosinates, sulfates, isethionates, taurates, phosphates, lactylates, glutamates, and mixtures thereof.

Non-limiting examples of nonionic lathering surfactants and amphoteric surfactants for use in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Nonionic lathering surfactants useful herein include those selected from the group consisting of alkyl glucosides, alkyl polyglucosides, polyhydroxy fatty acid amides, alkoxylated fatty acid esters, lathering sucrose esters, amine oxides, and mixtures thereof.

The term “amphoteric lathering surfactant,” as used herein, is also intended to encompass zwitterionic surfactants, which are well known to formulators skilled in the art as a subset of amphoteric surfactants.

A wide variety of amphoteric lathering surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate. Non-limiting examples of amphoteric or zwitterionic surfactants are those selected from the group consisting of betaines, sultaines, hydroxysultaines, alkyliminoacetates, iminodialkanoates, aminoalkanoates, and mixtures thereof.

Additional compositions utilized in accordance with the present invention can comprise a wide range of optional ingredients. The CTFA International Cosmetic ingredient Dictionary, Sixth Edition, 1995, which is incorporated by reference herein in its entirety, describes a wide variety of non-limiting cosmetic and pharmaceutical ingredients commonly used in the skin care industry, which are suitable for use in the compositions of the present invention. Non-limiting examples of functional classes of ingredients are described at page 537 of this reference. Examples of these functional classes include: abrasives, anti-acne agents, anticaking agents, antioxidants, binders, biological additives, bulking agents, chelating agents, chemical additives, colorants, cosmetic astringents, cosmetic biocides, degreasers, denaturants, drug astringents, emulsifiers, external analgesics, film formers, fragrance components, humectants, opacifying agents, plasticizers, preservatives, propellants, reducing agents, skin bleaching agents, skin-conditioning agents (emollient, humectants, miscellaneous, and occlusive), skin protectants, solvents, foam boosters, hydrotropes, solubilizing agents, suspending agents (nonsurfactant), sunscreen agents, ultraviolet light absorbers, and viscosity increasing agents (aqueous and nonaqueous). Examples of other functional classes of materials useful herein that are well known to one of ordinary skill in the art include solubilizing agents, sequestrants, and keratolytics, and the like.

The aforementioned classes of ingredients are incorporated in a safe and effective amount. The term “safe and effective amount” as used herein, means an amount of an active ingredient high enough to modify the condition to be treated or to deliver the desired skin benefit, but low enough to avoid serious side effects, at a reasonable benefit to risk ratio within the scope of sound medical judgment.

In addition to home care and personal care end uses, the nonwoven cleaning article may be used in industrial and medical applications. For instance, the dual sided laminate may be useful in paint preparation and cleaning outdoor surfaces, such as lawn furniture, grills, and outdoor equipment, wherein the low linting attributes of the laminate may be desirable. Aqueous or non-aqueous functional industrial solvents include, oils, such as plant oils, animal oils, terpenoids, silicon oils, mineral oils, white mineral oils, paraffinic solvents, polybutylenes, polyisobutylenes, polyalphaolefins, and mixtures thereof, toluenes, sequestering agents, corrosion inhibitors, abrasives, petroleum distillates, and the combinations thereof.

A dual side medical cleaning article may incorporate an antimicrobial composition, including, but not limited to iodines, alcohols, such as such as ethanol or propanol, biocides, abrasives, metallic materials, such as metal oxide, metal salt, metal complex, metal alloy or mixtures thereof, bacteriostatic complexes, bactericidal complexs, and the combinations thereof.

The dual sided cleaning article of the present invention is particularly suitable for dispensing from a tub of stacked, folded wipes, or for dispensing as “pop-up” wipes, in which the cleaning article is stored in the tub as a perforated continuous roll, wherein upon pulling a wipe out of the tub, an edge of the next wipe is presented for easy dispensing. The wipes of the present invention can be folded in any of various known folding patterns, such as C-folding, but is preferably Z-folded. A Z-folded configuration enables a folded stack of wipes to be interleaved with overlapping portions. The dual sided cleaning article may be packaged in various convenient forms, whereby the method of packaging is not meant to be a limitation of the present invention.

From the foregoing, numerous modifications and variations can be effected without departing from the true spirit and scope of the novel concept of the present invention. It is to be understood that no limitation with respect to the specific embodiment disclosed herein is intended or should be inferred. The disclosure is intended to cover, by the appended claims, all such modifications as fall within the scope of the claims.

What is claimed is:

1. A method of making a nonwoven dual sided home care cleaning article comprising the steps of:
a. providing a nonwoven fabric comprised of continuous bonded regions and at least two or more distinct pillow regions, wherein said nonwoven fabric comprises an air permeable precursor web and a meltblown precursor web comprising filaments in the range of 5-50 microns that are thermally bonded to form said cleaning article; said bonding regions define at least two or more distinct pillow regions comprising layers that are essentially free of any integration; and
b. a cleansing composition comprising an effective amount of a cleansing surfactant, said aqueous liquid cleansing composition being coated onto and/or impregnated into said substrate to the extent of from 50% to 500% by weight of the substrate.

2. A method of making a nonwoven dual sided home care cleaning article as in claim 1, wherein said cleansing composition is an aqueous or non-aqueous composition.

3. A method of making a nonwoven dual sided home care cleaning article as in claim 1, wherein said cleansing composition is selected from the group consisting of alkylpolysaccharides, alkyl ethoxylates, alkyl sulfonates, organic solvents, mono- or polycarboxylic acids, odor control agents, peroxides, hydrogen peroxides, thickening polymers, aqueous solvent systems, suds suppressors, perfumes or fragrances, detergent adjuvants, buffers, preservatives, antibacterial agents, colorants, bleaching agents, abrasive compounds, degreasers, chelants, enzymes, hydrotropes, and the combinations thereof.

4. A method of making a nonwoven dual sided personal care cleaning article comprising the steps of:
a. providing a nonwoven fabric comprised of continuous bonded regions and at least two or more distinct pillow regions, wherein said nonwoven fabric comprises an air permeable precursor web and a meltblown precursor web comprising filaments in the range of 5-50 microns that are thermally bonded to form said cleaning article; said bonding regions define at least two or more distinct pillow regions comprising layers that are essentially free of any integration; and
b. a cleansing composition comprising an effective amount of a cleansing surfactant, said aqueous liquid cleansing composition being coated onto and/or impregnated into said substrate to the extent of from 50% to 500% by weight of the substrate.

5. A method of making a nonwoven dual sided personal care cleaning article as in claim 4, wherein said cleansing composition is an aqueous or non-aqueous composition.

6. A method of making a nonwoven dual sided personal care cleaning article as in claim 4, wherein said cleansing composition is selected from the group consisting of abrasives, anti-acne agents, anticaking agents, antioxidants, binders, biological additives, bulking agents, chelating agents, chemical additives, natural additives, colorants, vitamins, cosmetic astringents, cosmetic biocides, denaturants, drug astringents, emulsifiers, external analgesics, film formers, fragrance components, humectants, emollients, opacifying agents, plasticizers, preservatives, propellants, reducing agents, skin bleaching agents, skin-conditioning agents, skin protectants, solvents, foam boosters, hydrotropes, solubilizing agents, suspending agents, sunscreen agents, ultraviolet light absorbers, viscosity increasing agents, and the combinations thereof.

7. A method of making a nonwoven dual sided industrial cleaning article comprising the steps of:
a. providing a nonwoven fabric comprised of continuous bonded regions and at least two or more distinct pillow regions, wherein said nonwoven fabric comprises an air permeable precursor web and a meltblown precursor web comprising filaments in the range of 5-50 microns that are thermally bonded to form said cleaning article; said bonding regions define at least two or more distinct pillow regions comprising layers that are essentially free of any integration; and
b. a cleansing composition comprising an effective amount of a cleansing surfactant, said aqueous liquid cleansing composition being coated onto or impregnated into said substrate to the extent of from 50% to 500% by weight of the substrate.

8. A method of making a nonwoven dual sided industrial cleaning article as in claim 7, wherein said cleansing composition is an aqueous or non-aqueous composition.

9. A method of making a nonwoven dual sided industrial cleaning article as in claim 7, wherein said cleansing composition is a solvent selected from the group consisting of oils, paraffinic solvents, polybutylenes, polyisobutylenes, polyalphaolefins, toluenes, sequestering agents, corrosion inhibitors, abrasives, petroleum distillates, and the combinations thereof.

10. A method of making a nonwoven dual sided medical cleaning article comprising the steps of:
a. providing a nonwoven fabric comprised of continuous bonded regions and at least two or more distinct pillow regions, wherein said nonwoven fabric comprises an air permeable precursor web and a meltblown precursor web comprising filaments in the range of 5-50 microns that are thermally bonded to form said cleaning article; said bonding regions define at least two or more distinct pillow regions comprising layers that are essentially free of any integration; and
b. a cleansing composition comprising an effective amount of a cleansing surfactant, said aqueous liquid cleansing composition being coated onto and/or impregnated into said substrate to the extent of from 50% to 500% by weight of the substrate.

11. A method of making a nonwoven dual sided personal care cleaning article as in claim 10, wherein said cleansing composition is an aqueous or non-aqueous composition.

12. A method of making a nonwoven dual sided personal care cleaning article as in claim 10, wherein said cleansing composition is selected from the group consisting of iodines, alcohols, biocides, abrasives, metallic materials, bacteriostatic complexes, bactericidal complexes, and the combinations thereof.
